(19) United States
(12) Patent Application Publication
(10) Pub. No.: US 2024/0255228 A1
(43) Pub. Date: Aug. 1, 2024

(54) HEAT SINK AND METHOD FOR MANUFACTURING HEAT SINK

(71) Applicant: Mitsubishi Electric Corporation, Tokyo (JP)

(72) Inventors: Shigenobu TOCHIYAMA, Tokyo (JP); Masayoshi TAMURA, Tokyo (JP)

(73) Assignee: Mitsubishi Electric Corporation, Tokyo (JP)

(21) Appl. No.: 18/291,835

(22) PCT Filed: Nov. 4, 2021
(86) PCT No.: PCT/JP2021/040523

§ 371 Date: Jan. 24, 2024

(51) Int. Cl. F28D 9/00; B23K 1/00; B23K 20/02; B23K 20/12; B23K 101/00; B23P 15/26

(52) U.S. Cl. CPC F28D 9/0075; B23K 1/0012; B23K 20/02; B23K 20/122; B23K 20/129; B23P 15/26; B23K 2101/00; B23P 2700/10

(57) ABSTRACT

A flowing direction of a cooling liquid introduced into a heat sink is a direction perpendicular to a stacking direction. Each of the plates has a plurality of holes. In a state in which the plates are stacked in the stacking direction, flow paths formed by the holes of the plates being connected to each other in the stacking direction and the flowing direction have helical shapes toward the flowing direction. Helix center axes at helix centers of the flow paths are formed in only one row in the stacking direction.

### TECHNICAL FIELD

The present disclosure relates to a heat sink and a method for manufacturing the heat sink.

### BACKGROUND ART

Among conventional heat sinks, there is a liquid-cooling type in which a main body with which a heat generation body as a cooling target contacts is cooled by a coolant, whereby the heat generation body is cooled. In such a liquid-cooling heat sink, a flow path is formed inside the main body so that the coolant flows therethrough. For example, Patent Document 1 discloses a heat sink formed by a stacked body of a first plate and a second plate which have flat-plate shapes and are obtained by metal-plate stamping and shaping, both plates being configured such that multiple elongated longitudinal members provided in the flow direction of a cooling liquid and arranged in parallel away from each other in a direction perpendicular to the flow direction of the cooling liquid, and oblique members obliquely connecting the adjacent longitudinal members, are formed integrally, and the respective longitudinal members of both plates overlap each other in an aligned manner and the respective oblique members are arranged away from each other in the flow direction and are directed opposite to each other.

### CITATION LIST

### Patent Document

Patent Document 1: Japanese Laid-Open Patent Publication No. 2010-114174

### SUMMARY OF THE INVENTION

### Problem to be Solved by the Invention

In the conventional heat sink and the conventional method for manufacturing the heat sink, the cooling liquid regularly meanders along the flow path and rotates helically, to promote heat transfer. In the conventional configuration, helically rotating flows are produced in a plurality of rows in the stacking direction. Heat generated at the heat generation body (object to be cooled) located on the top layer of the stacked plates transfers to the stacked plates and is dissipated to the cooling liquid. The temperature of the plate close to the heat generation body is highest, and a plate farther from the heat generation body has a lower temperature.

The greater the difference between the temperature of the plate and the temperature of the cooling liquid is, the larger the heat dissipation amount from the plate is. Therefore, near the heat generation body, a large amount of heat is dissipated to the cooling liquid through a helically rotating flow locally produced, and in an area far from the heat generation body, a smaller amount of heat than near the heat generation body is dissipated through a helically rotating flow present in a row different from the former helically rotating flow.

Thus, the cooling liquid present in the area close to the heat generation body has a high temperature and the cooling liquid present in the area far from the heat generation body has a low temperature. However, there is a problem that heat dissipation efficiency is lowered if the temperature of the cooling liquid becomes high concentrically in the region close to the heat generation body where the difference between the temperature of the plate and the temperature of the cooling liquid would be originally greatest.

Heat to be dissipated to the cooling liquid is conducted inside metal until reaching the cooling liquid. Therefore, as the sectional area of a heat path inside the metal becomes larger, heat is more readily transferred to a part far from the heat generation body, so that heat dissipation performance is enhanced. Meanwhile, when the sectional area of the heat path inside the metal is large, the contact area between the cooling liquid and the metal, i.e., a heat dissipation area, is hindered from being enlarged, thus having a problem that heat dissipation efficiency is lowered.

Parts where the adjacent plates contact with each other are limited and there are gaps therebetween. Therefore, although the heat dissipation area is large, the sectional area of the heat conduction path inside the metal is small and it is difficult to conduct heat to an area far from the heat generation body, thus having a problem that heat dissipation efficiency is lowered.

The present disclosure has been made to solve the above problems, and an object of the present disclosure is to provide a heat sink and a method for manufacturing the heat sink that enable improvement in heat dissipation efficiency.

### Means to Solve the Problem

A heat sink according to the present disclosure is a heat sink having a fin portion in which a plurality of plates are stacked in a stacking direction. A flowing direction of a cooling liquid introduced into the heat sink is a direction perpendicular to the stacking direction. Each of the plates has a plurality of holes. In a state in which the plates are stacked in the stacking direction, flow paths formed by the holes of the plates being connected to each other in the stacking direction and the flowing direction have helical shapes toward the flowing direction. Helix center axes at helix centers of the flow paths are formed in only one row in the stacking direction.

A method for manufacturing a heat sink according to the present disclosure is a method for manufacturing the above heat sink, the method including: a first step of forming the plurality of holes in each of the plates; and a second step of stacking the plates in the stacking direction so that the holes of the plates are connected to each other in the stacking direction and the flowing direction, thus forming the flow paths having helical shapes toward the flowing direction.

### Effect of the Invention

The heat sink and the method for manufacturing the heat sink according to the present disclosure enable improvement in heat dissipation efficiency of the heat sink.

### BRIEF DESCRIPTION OF THE DRAWINGS

FIG. 1A is a perspective view showing a configuration of a heat sink according to embodiment 1, and FIG. 1B is a sectional view showing a configuration of the heat sink shown in FIG. 1A.

FIG. 2A is a front view of a base portion, a fin portion, and a heat generation body mounted thereto, which are taken out from the heat sink shown in FIG. 1, and FIG. 2B is an enlarged side view of the base portion, the fin portion, and the heat generation body mounted thereto, of the heat sink shown in FIG. 3A, as seen from an arrow K side.

FIG. 3 is an exploded perspective view showing a configuration of the base portion, the fin portion, and the heat generation body mounted thereto, of the heat sink shown in FIG. 2.

FIG. 4 is a perspective view of the base portion and the fin portion of the heat sink shown in FIG. 2, with the fin portion shown on the top side.

FIG. 5A is an enlarged top view showing a configuration of a plate composing the fin portion of the heat sink shown in FIG. 4, FIG. 5B is an enlarged top view showing a configuration of a plate composing the fin portion of the heat sink shown in FIG. 4, FIG. 5C is an enlarged top view showing a configuration of a plate composing the fin portion of the heat sink shown in FIG. 4, FIG. 5D is an enlarged top view showing a configuration of a plate composing the fin portion of the heat sink shown in FIG. 4, FIG. 5E is an enlarged top view showing a configuration of a plate composing the fin portion of the heat sink shown in FIG. 4, FIG. 5F is an enlarged top view showing a configuration of a plate composing the fin portion of the heat sink shown in FIG. 4, FIG. 5G is an enlarged top view showing a configuration of a plate composing the fin portion of the heat sink shown in FIG. 4, FIG. 5H is an enlarged top view showing a configuration of a plate composing the fin portion of the heat sink shown in FIG. 4, and FIG. 5I is an enlarged top view showing a configuration of a plate composing the fin portion of the heat sink shown in FIG. 4.

FIG. 6 is a front view of the base portion and the fin portion taken out from the heat sink shown in FIG. 2.

FIG. 7A is a sectional view of the base portion and the fin portion shown in FIG. 6 along line KA-KA, FIG. 7B is a sectional view of the base portion and the fin portion shown in FIG. 6 along line KB-KB, FIG. 7C is a sectional view of the base portion and the fin portion shown in FIG. 6 along line KC-KC, FIG. 7D is a sectional view of the base portion and the fin portion shown in FIG. 6 along line KD-KD, and FIG. 7E is a sectional view of the base portion and the fin portion shown in FIG. 6 along line KE-KE.

FIG. 8A is an enlarged view showing a configuration of a part of the fin portion shown in FIG. 7A, FIG. 8B is an enlarged view showing a configuration of a part of the fin portion shown in FIG. 7B, FIG. 8C is an enlarged view showing a configuration of a part shown in FIG. 7C, FIG. 8D is an enlarged view showing a configuration of a part shown in FIG. 7D, and FIG. 8E is an enlarged view showing a configuration of a part shown in FIG. 7E.

FIG. 9 shows flows of a cooling liquid inside flow paths formed by connection between holes of the plates of the heat sink shown in FIG. 1.

FIG. 10 is a contour diagram showing, in a grayscale manner according to a speed, flow lines of flows of the cooling liquid in the heat sink shown in FIG. 1, which are derived through three-dimensional fluid simulation.

FIG. 11A is a plan view of a base portion and heat generation bodies mounted thereto, of a heat sink according to embodiment 2, and FIG. 11B is an enlarged left side view of the base portion, a fin portion, and the heat generation bodies mounted thereto, of the heat sink shown in FIG. 11A.

FIG. 12A is a plan view showing a configuration of a plate of a heat sink according to embodiment 3, and FIG. 12B is an enlarged plan view of a broken-line part shown in FIG. 12A.

FIG. 13 is a side view of the plate of the heat sink according to embodiment 3.

FIG. 14A is a plan view showing a configuration of a fin portion material for a heat sink according to embodiment 5, and FIG. 14B is a plan view showing a configuration of a fin portion cut out from FIG. 14A.

### DESCRIPTION OF EMBODIMENTS

In the following description, the same or corresponding parts in the drawings are denoted by the same reference characters and the description thereof is omitted as appropriate. Regarding directions around the heat sink, a direction in which plates described later are stacked is defined as a stacking direction Y, a direction which is perpendicular to the stacking direction Y and in which a cooling liquid flows is defined as a flowing direction Z, and a direction perpendicular to the stacking direction Y and the flowing direction Z is defined as a perpendicular direction X. Therefore, parts forming the heat sink will be described with directions indicated on the basis of the above directions. The same applies to all the following embodiments and the description thereof is omitted as appropriate.

### Embodiment 1

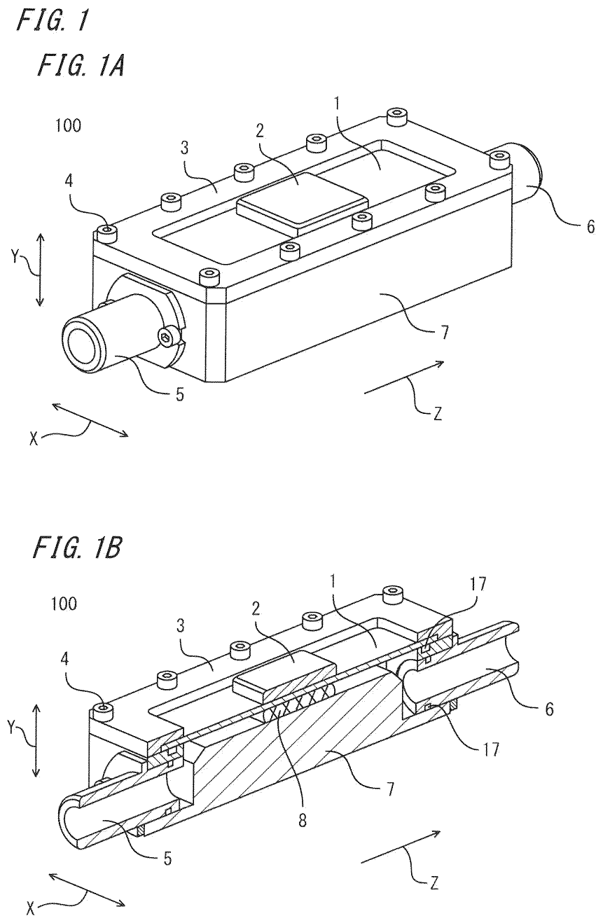

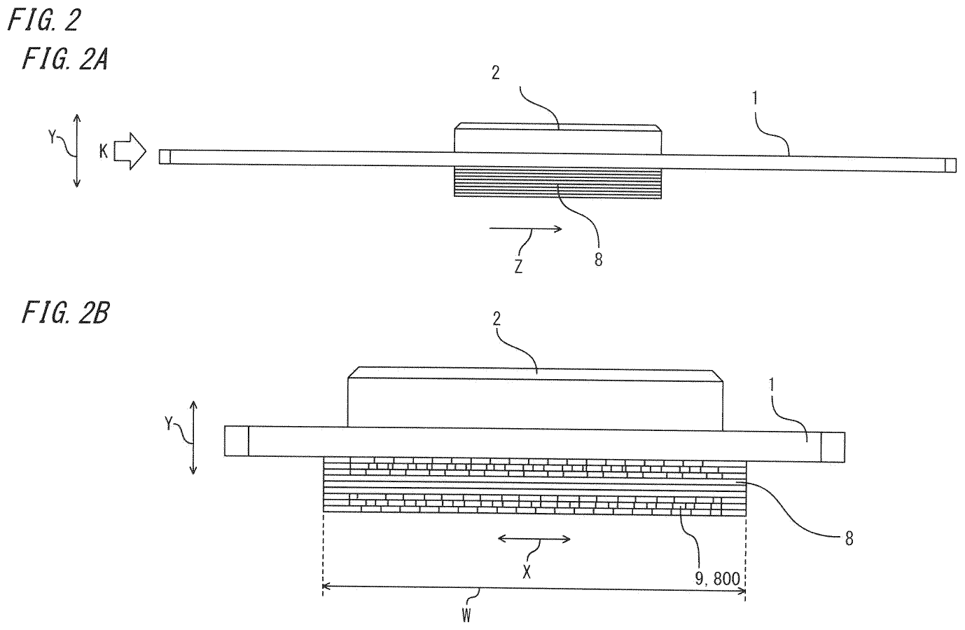

FIG. 1A is a perspective view showing a configuration of a heat sink according to embodiment 1. FIG. 1B is a sectional view showing a configuration of the heat sink shown in FIG. 1A. FIG. 2A is a front view showing a configuration of a base portion, a fin portion, and a heat generation body mounted thereto, of the heat sink shown in FIG. 1. FIG. 2B is a side view showing a configuration of the base portion, the fin portion, and the heat generation body mounted thereto, of the heat sink shown in FIG. 2A, as seen from an arrow K side.

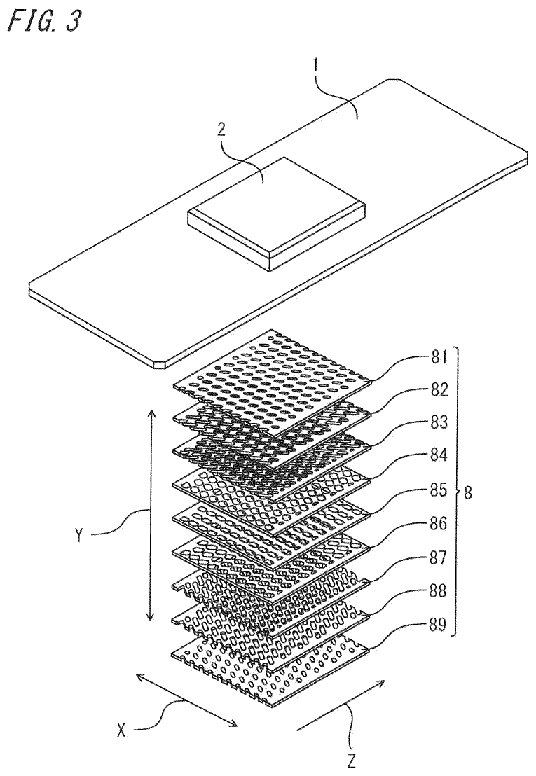

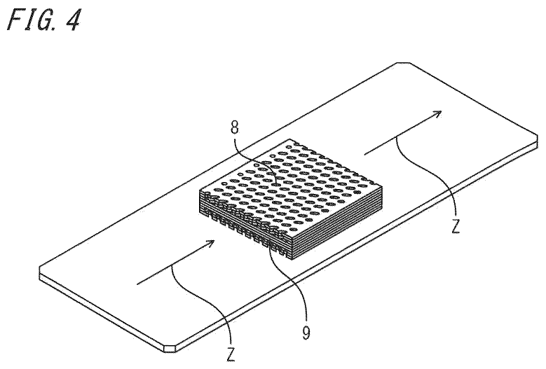

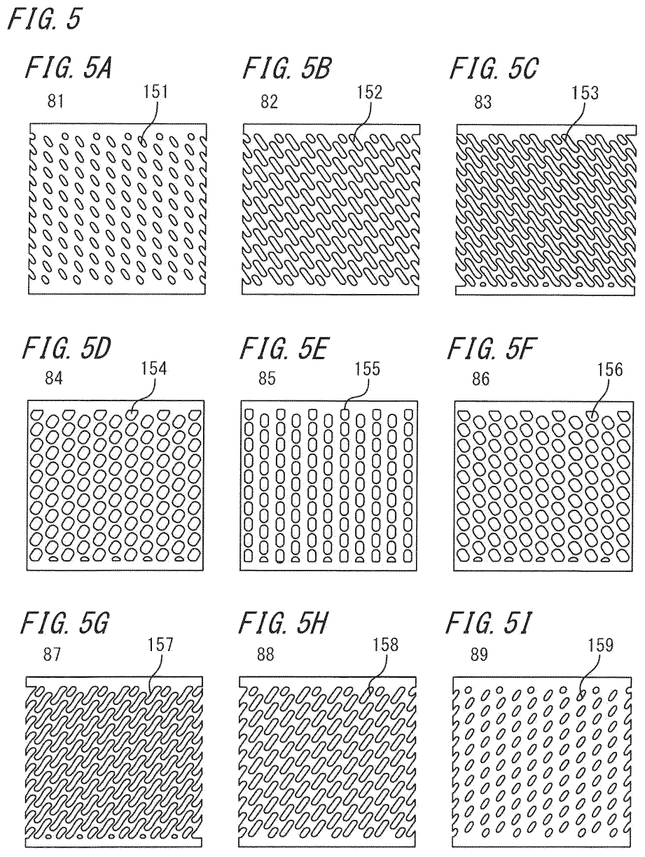

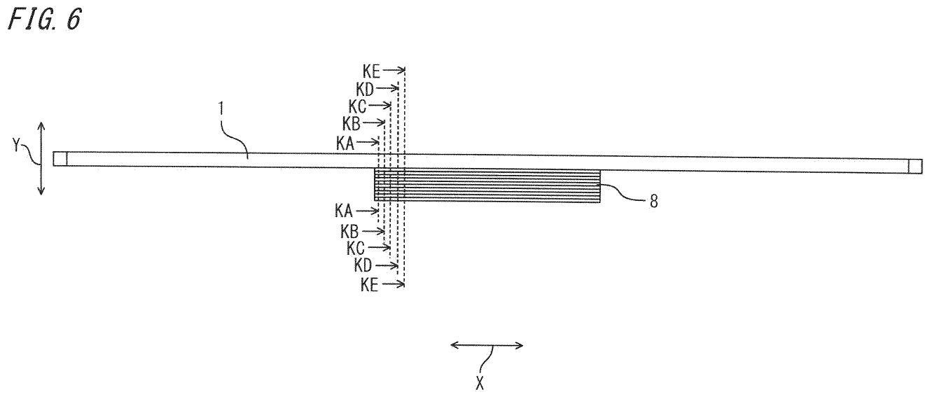

FIG. 3 is an exploded perspective view of the base portion, the fin portion, and the heat generation body of the heat sink shown in FIG. 2. FIG. 4 is a perspective view in which the fin portion of the heat sink shown in FIG. 2 is shown on the top side. FIG. 5A to FIG. 5I are top views of plates forming the fin portion shown in FIG. 5. FIG. 6 is a front view showing a configuration of the base portion and the fin portion taken out from the heat sink shown in FIG. 1.

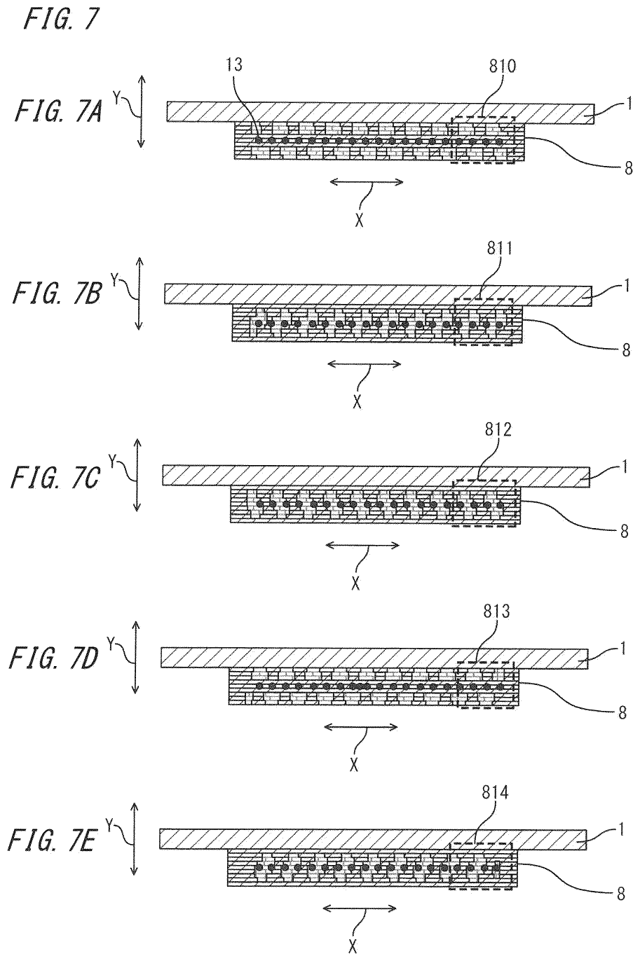

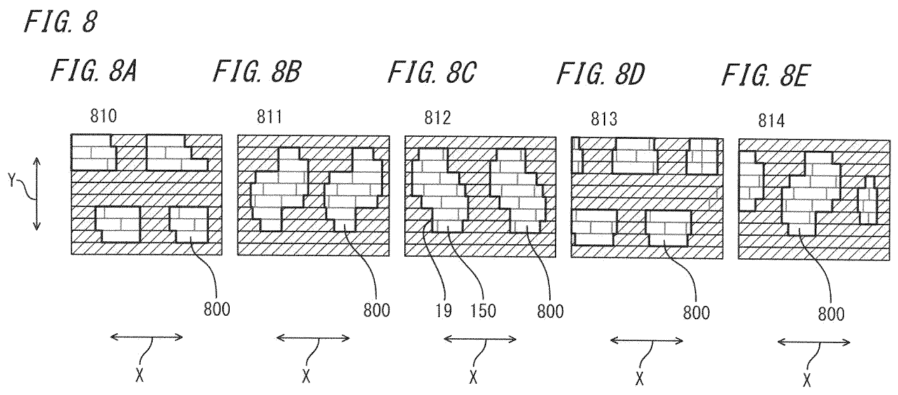

FIG. 7A is a sectional view of the base portion and the fin portion shown in FIG. 6 along line KA-KA. FIG. 7B is a sectional view of the base portion and the fin portion shown in FIG. 6 along line KB-KB. FIG. 7C is a sectional view of the base portion and the fin portion shown in FIG. 6 along line KC-KC. FIG. 7D is a sectional view of the base portion and the fin portion shown in FIG. 6 along line KD-KD. FIG. 7E is a sectional view of the base portion and the fin portion shown in FIG. 6 along line KE-KE. FIG. 8A is an enlarged view showing a configuration of a part 810 of the flow path cross-section shown in FIG. 7A. FIG. 8B is an enlarged view showing a configuration of a part 811 of the flow path cross-section shown in FIG. 7B. FIG. 8C is an enlarged view showing a configuration of a part 812 of the flow path cross-section shown in FIG. 7C. FIG. 8D is an enlarged view showing a configuration of a part 813 of the flow path cross-section shown in FIG. 7D. FIG. 8E is an enlarged view showing a configuration of a part 814 of the flow path cross-section shown in FIG. 7E.

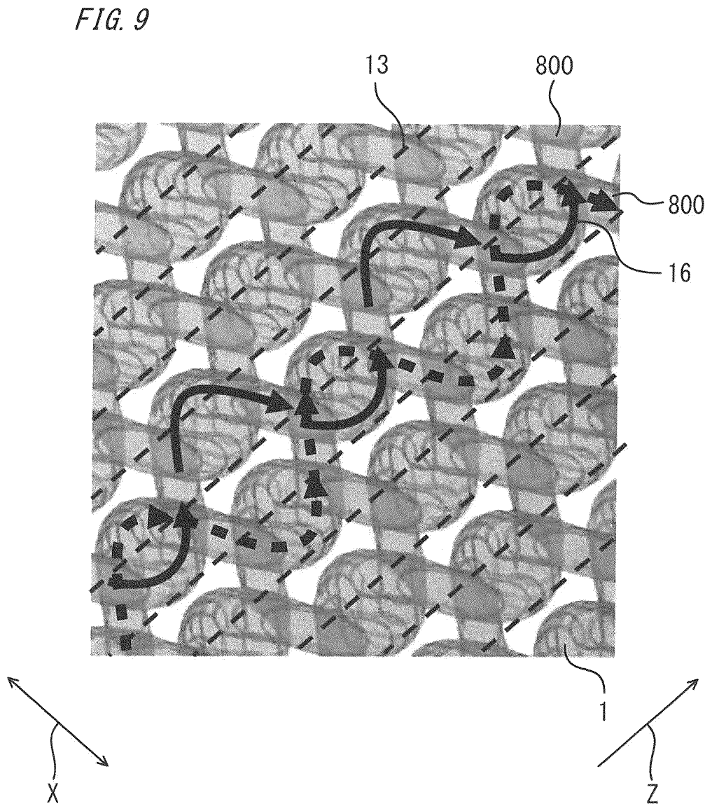

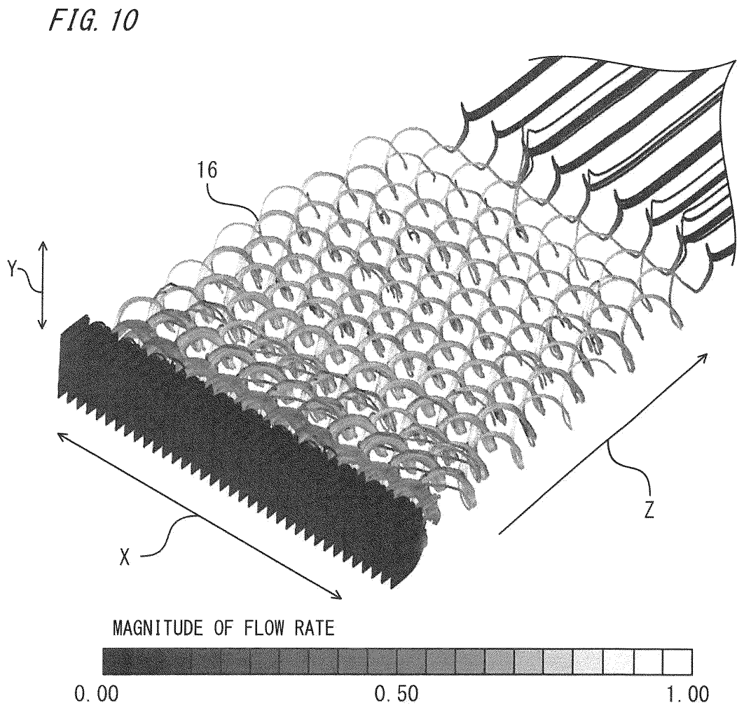

FIG. 9 shows flows of a cooling liquid inside flow paths formed by connection between holes of the plates of the heat sink shown in FIG. 1. FIG. 10 is a contour diagram showing, in a grayscale manner according to a speed, flow lines of flows of the cooling liquid in the heat sink shown in FIG. 1, which are derived through three-dimensional fluid simulation.

As shown in FIG. 1 and FIG. 2, a heat sink 100 according to embodiment 1 is formed such that a base portion 1 on which a heat generation body 2 is mounted at one surface and a fin portion 8 having flow paths 800 (see FIG. 8) described later is provided at a surface opposite to the heat generation body 2, is combined with a water jacket 7. The water-tightness between the base portion 1 and the water jacket 7 is kept by a structure in which the base portion 1 is provided above the water jacket 7 with O rings 17 interposed therebetween and the base portion 1 is pressed to the water jacket 7 by a fastening plate 3 and fastened by bolts 4.

A supply path 5 for supplying a cooling liquid and a discharge path 6 for discharging the cooling liquid are connected to the water jacket 7. The cooling liquid is introduced from the supply path 5, passes through flow path entrances 9 (FIG. 2B) to flow into flow paths 800 of the fin portion 8, and flows therethrough to be discharged from the discharge path 6.

As shown in FIG. 3, FIG. 4, and FIG. 5, plates 81, 82, 83, 84, 85, 86, 87, 88, 89 (hereinafter, when all the plates are mentioned, they are referred to as plates 81 to 89, and when any of the plates is mentioned, the plate is referred to as plate 80) respectively having holes 151, 152, 153, 154, 155, 156, 157, 158, 159 with different patterns (hereinafter, when all the holes are mentioned, they are referred to as holes 151 to 159, and when any of the holes is mentioned, the hole is referred to as hole 150) are stacked, so that predetermined holes 150 are connected to each other in the stacking direction Y and the flowing direction Z, thus forming the flow paths 800 of the fin portion 8.

The flow paths 800 will be described with reference to FIG. 6, FIG. 7, FIG. 8, and FIG. 9. The predetermined holes 150 are connected to each other in the stacking direction Y and the flowing direction Z, to form the flow path 800 (see parts 810, 811, 812, 813, 814, 815). As shown in FIG. 9, in the fin portion 8, a plurality of helical flow paths 800 extending toward the flowing direction Z of the cooling liquid are formed.

As shown in FIG. 7, helix center axes 13 of the helical flow paths 800 are formed in only one row in the stacking direction Y of the plates 81 to 89 of the fin portion 8, and the helix center axes 13 are formed in a plurality of rows in a perpendicular direction X perpendicular to the stacking direction Y of the plates 81 to 89 and the flowing direction Z of the cooling liquid. In the drawings (except for FIG. 9) in the present embodiment 1 and the subsequent embodiments, the positions of the helix center axes 13 are indicated by black circles.

The helical flow paths 800 adjacent in the perpendicular direction X are formed so as to be entangled with each other. Specifically, as shown in FIG. 8 and FIG. 9, a helix R1 indicated by solid-line arrows and a helix R2 indicated by broken-line arrows of the helical flow paths 800 are partway entangled and partially connected to each other. The helices R1, R2 shown in FIG. 9 are merely examples and other parts are also formed in the same relationship.

In order to verify what behavior the flow of the cooling liquid has when the cooling liquid flows through the flow paths 800, a result of numerical calculation through three-dimensional fluid simulation is shown in FIG. 10. As shown in FIG. 10, it is found that flow lines 16 of the cooling liquid are helically formed in a plurality of rows along the perpendicular direction X of the plates 81 to 89. As shown in FIG. 8A to FIG. 8E, heat generated from the heat generation body 2 is conducted to the base portion 1 and the plates 81 to 89 forming the fin portion 8, and then is dissipated from wall surfaces of the flow paths 800 to the cooling liquid.

In the heat sink 100, temperature unevenness does not occur in the cooling liquid and a range from a part close to the heat generation body 2 to a far area in the stacking direction Y can be made to have a constant temperature, whereby heat dissipation performance of the heat sink 100 is enhanced. Therefore, how to prevent occurrence of temperature unevenness in the cooling liquid is important. In the heat sink 100 according to embodiment 1, the helix center axes 13 of the helical flow paths 800 formed by the predetermined holes 150 of the plates 81 to 89 being connected to each other in the stacking direction Y and the flowing direction Z are formed in only one row in the stacking direction Y, and therefore the flow of the cooling liquid in the fin portion 8 is assuredly spread through one-stroke paths from a part near the heat generation body 2 to a far area.

Thus, from a part near the heat generation body 2 to a far area, the cooling liquid is uniformly agitated so that temperature unevenness of the cooling liquid is eliminated, whereby heat dissipation performance is enhanced. With this configuration, the heat conduction path sectional area and the heat dissipation area in the fin portion 8 can be ensured in a simple manner.

The helix center axes 13 are formed in a plurality of rows in the perpendicular direction X of the fin portion 8 and the helical flow paths 800 adjacent to each other on a plane are formed so as to be entangled with each other. Therefore, by arranging the plates adjacent in the stacking direction Y with the positions of the holes 150 slightly displaced from each other, a step portion 19 having a stepped shape as shown in FIG. 8C is formed in the flow path 800, whereby the heat dissipation area can be increased. In addition, since the plates 81 to 89 adjacent in the stacking direction Y are connected without gaps therebetween, the sectional area of the heat conduction path can also be increased, whereby heat dissipation performance can be improved.

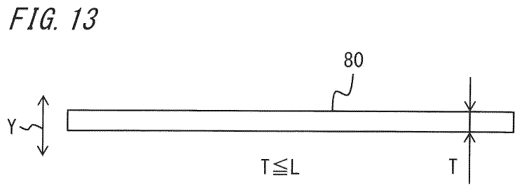

The base portion 1 on which the heat generation body 2 is mounted is parallel to the flowing direction Z of the cooling liquid, and in general, a length W (see FIG. 2) of one side of a mounting surface on the side where the heat generation body 2 is mounted is sufficiently greater than a thickness T (see FIG. 13) of each one of the plates 81 to 89. Accordingly, if the stacking direction of the plates is the direction of the length W, the number of necessary plates increases. However, in the present disclosure, the stacking direction Y of the plates 80 is set in the direction perpendicular to the flowing direction Z of the cooling liquid and the perpendicular direction X. Thus, the number of necessary plates 80 can be decreased and contact surfaces or joining surfaces between the plates 81 to 89 can be decreased, whereby manufacturing can be facilitated and the thermal resistance can be reduced, i.e., heat dissipation performance can be improved.

As the plates 80, a material having a high thermal conductivity, such as aluminum or copper, is used. The plates 80 are stacked with a pressure applied, whereby the plates 80 adjacent in the stacking direction Y are pressed into close contact with each other. Thus, the thermal resistance between the contact surfaces is reduced, so that heat dissipation performance is improved. At this time, the plates 80 may be fixed in close contact by swaging or the like so as not to be separated from each other. The plates 80 may be metal-joined by brazing, diffusion welding, or friction stir welding, to form a joined portion, whereby the contact thermal resistance can be made zero and heat dissipation performance can be further improved.

The shapes of the holes 150 and the number of the plates 80 shown in FIG. 5 are merely an example. The shapes of the holes 150 and the number of the plates 80 may be arbitrarily set as long as the flow paths 800 formed by the holes 150 of the plates 80 being connected to each other in the stacking direction Y and the flowing direction Z have helical shapes, the helix center axes 13 are formed in only one row in the stacking direction Y of the plate 80, the helix center axes 13 are formed in a plurality of rows in the perpendicular direction X of the fin portion 8, and the helical flow paths 800 adjacent in the perpendicular direction X are formed so as to be entangled and partially connected to each other.

For fastening of the base portion 1 and the water jacket 7 and ensuring the water-tightness therebetween, it is not always necessary to use the fastening plate 3. The base portion 1 and the water jacket 7 may be directly fastened with the bolts 4, liquid gaskets may be used instead of the 0 rings 17, or the base portion 1 and the water jacket 7 may be directly joined by brazing or friction stir welding.

Without using the base portion 1 and the water jacket 7, plates not having holes may be brazed to upper and lower surfaces in the stacking direction Y of the plates 81 to 89, to form the flow paths 800 with water-tightness ensured. The flow paths 800 shown in FIG. 7, FIG. 8, and FIG. 9 have parts where the adjacent flow paths 800 are partway entangled with each other, but they do not always need to be entangled but may be constantly separated from each other.

Next, a method for manufacturing the heat sink of embodiment 1 configured as described above will be described. Multiple different holes 151 to 159 are formed in the respective plates 81 to 89, thus preparing the plates 81 to 89 (first step). Next, the plates 81 to 89 are stacked in the stacking direction Y, so that predetermined holes 150 of the plates 81 to 89 are connected to each other in the stacking direction Y and the flowing direction Z, thus forming the helical flow paths 800 (second step).

After the second step, in a third step, the plates 81 to 89 adjacent in the stacking direction Y are pressed into close contact with each other by applying a pressure in the stacking direction Y. Alternatively, parts where the plates 81 to 89 adjacent in the stacking direction Y contact with each other are joined as a joined portion by brazing. Alternatively, parts where the plates 81 to 89 adjacent in the stacking direction Y contact with each other are joined as a joined portion by diffusion welding. Alternatively, parts where the plates 81 to 89 adjacent in the stacking direction Y contact with each other are joined as a joined portion by friction stir welding. Thus, the fin portion 8 is formed. Then, the heat sink 100 is formed using the fin portion 8.

The heat sink of embodiment 1 configured as described above is a heat sink having a fin portion in which a plurality of plates are stacked in a stacking direction. A flowing direction of a cooling liquid introduced into the heat sink is a direction perpendicular to the stacking direction. Each of the plates has a plurality of holes. In a state in which the plates are stacked in the stacking direction, flow paths formed by the holes of the plates being connected to each other in the stacking direction and the flowing direction have helical shapes toward the flowing direction. Helix center axes at helix centers of the flow paths are formed in only one row in the stacking direction.

The method for manufacturing the heat sink of embodiment 1 configured as described above is a method for manufacturing the above heat sink, the method including: a first step of forming the plurality of holes in each of the plates; and a second step of stacking the plates in the stacking direction so that the holes of the plates are connected to each other in the stacking direction and the flowing direction, thus forming the flow paths having helical shapes toward the flowing direction.

Thus, the helical flow paths for the cooling liquid, formed by the holes of the plates being connected to each other, are configured such that helix center axes of the helices are formed in only one row in the stacking direction, and the flow of the cooling liquid is assuredly spread through one-stroke paths from a part near the heat generation body to a far area in the stacking direction. Thus, from a part near the heat generation body to a far area, the cooling liquid is uniformly agitated so that temperature unevenness is eliminated, whereby heat dissipation performance is enhanced.

Further, in the heat sink of embodiment 1, the fin portion has a plurality of kinds of the plates with different patterns of the holes.

Thus, the helical flow paths can be formed in a simple manner.

Further, in the heat sink of embodiment 1, the flow paths are formed in a plurality of rows in a perpendicular direction perpendicular to the stacking direction and the flowing direction.

Thus, since the helix center axes are formed in a plurality of rows in the perpendicular direction, the heat dissipation area can be increased in a simple manner.

Further, in the heat sink of embodiment 1, the flow paths are formed such that the flow paths adjacent in the perpendicular direction are partially connected to each other.

Thus, since the flow paths adjacent in the perpendicular direction are entangled and partially connected to each other, the heat dissipation area can be further increased.

Further, in the heat sink of embodiment 1, the plates adjacent in the stacking direction are formed by being pressed into close contact with each other in the stacking direction.

Further, the method for manufacturing the heat sink of embodiment 1 includes a third step of applying a pressure in the stacking direction so that the plates adjacent in the stacking direction are pressed into close contact with each other, after the second step.

Thus, since the plates adjacent in the stacking direction are connected without gaps therebetween, the sectional area of the heat conduction path can also be increased, whereby heat dissipation performance can be improved.

Further, in the heat sink of embodiment 1, a joined portion is formed at parts where the plates adjacent in the stacking direction contact with each other.

Thus, the plates can be assuredly connected to each other in the stacking direction.

Further, in the heat sink of embodiment 1, the joined portion is formed by brazing.

Further, the method for manufacturing the heat sink of embodiment 1 includes a third step of joining, by brazing, parts where the plates adjacent in the stacking direction contact with each other, after the second step.

Thus, the contact thermal resistance can be made zero and heat dissipation performance can be further improved.

Further, in the heat sink of embodiment 1, the joined portion is formed by diffusion welding.

Further, the method for manufacturing the heat sink of embodiment 1 includes a third step of performing diffusion welding at parts where the plates adjacent in the stacking direction contact with each other, after the second step.

Thus, the contact thermal resistance can be made zero and heat dissipation performance can be further improved.

Further, in the heat sink of embodiment 1, the joined portion is formed by friction stir welding.

Further, the method for manufacturing the heat sink of embodiment 1 includes a third step of performing friction stir welding at parts where the plates adjacent in the stacking direction contact with each other, after the second step.

Thus, the contact thermal resistance can be made zero and heat dissipation performance can be further improved.

In the following embodiments, differences from the above embodiment 1 will be mainly described. Therefore, the description of the same parts as in the above embodiment 1 is omitted as appropriate.

### Embodiment 2

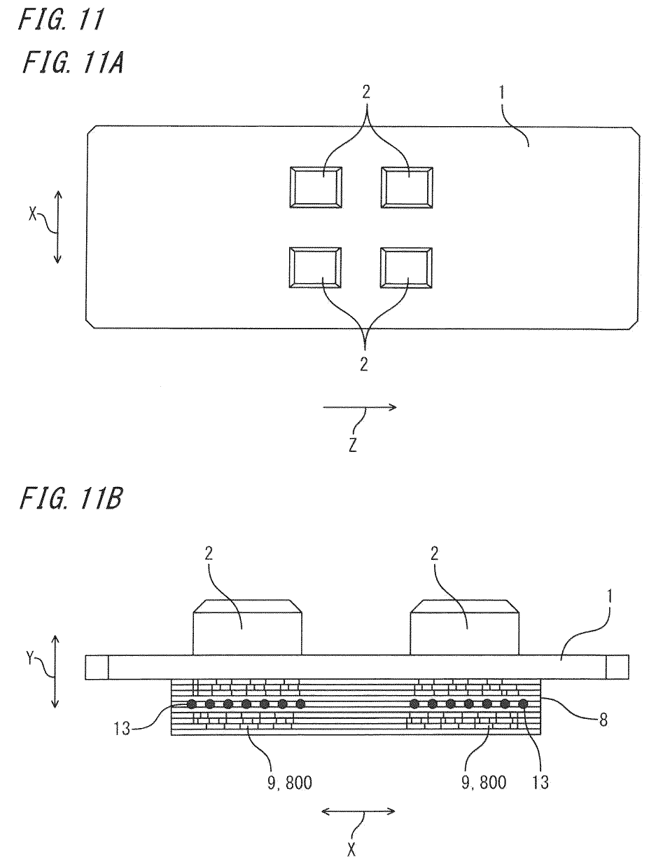

FIG. 11A is a plan view showing a configuration of a base portion and heat generation bodies mounted thereto, of a heat sink according to embodiment 2. FIG. 11B is an enlarged left side view of the base portion, a fin portion, and the heat generation bodies mounted thereto, of the heat sink shown in FIG. 11A.

As compared to the heat sink of the above embodiment 1, the heat sink of the present embodiment 2 is different in that a plurality of heat generation bodies 2 to be cooled by the heat sink are mounted. In each of areas in the fin portion 8 into which heat is transferred from the respective heat generation bodies 2, at least one or more helix center axes 13 of the flow paths 800 of the fin portion 8 are present. In FIG. 11B, as an example, seven helix center axes 13 are present per one heat generation body 2. Therefore, in the entire heat sink 100, fourteen helix center axes 13 are present, i.e., the helical flow paths 800 are formed at fourteen locations.

In an area where the heat generation body 2 to be cooled is not present, it is not necessary to provide the flow paths 800. By providing the helix center axes 13 of the flow paths 800 concentrically in the areas in the fin portion 8 into which heat is transferred from the heat generation bodies 2, the flow volume of the cooling liquid flowing into each one flow path 800 can be increased and therefore the flow rate of the cooling liquid can be increased, as compared to a case of providing the flow paths 800 also in an area in the fin portion 8 into which heat is not transferred from the heat generation bodies 2. As the flow rate of the cooling liquid increases, the heat transfer coefficient increases, so that heat dissipation performance can be improved.

In the heat sink of embodiment 2 configured as described above, the same effects as in the above embodiment 1 are provided, and in addition,
a plurality of heat generation bodies are allowed to be mounted to the heat sink, and the flow paths are formed in only areas into which heat is transferred from the respective heat generation bodies.

Thus, the flow volume of the cooling liquid flowing into each one flow path can be increased and therefore the flow rate of the cooling liquid can be increased. As the flow rate of the cooling liquid increases, the heat transfer coefficient increases, so that heat dissipation performance can be improved.

### Embodiment 3

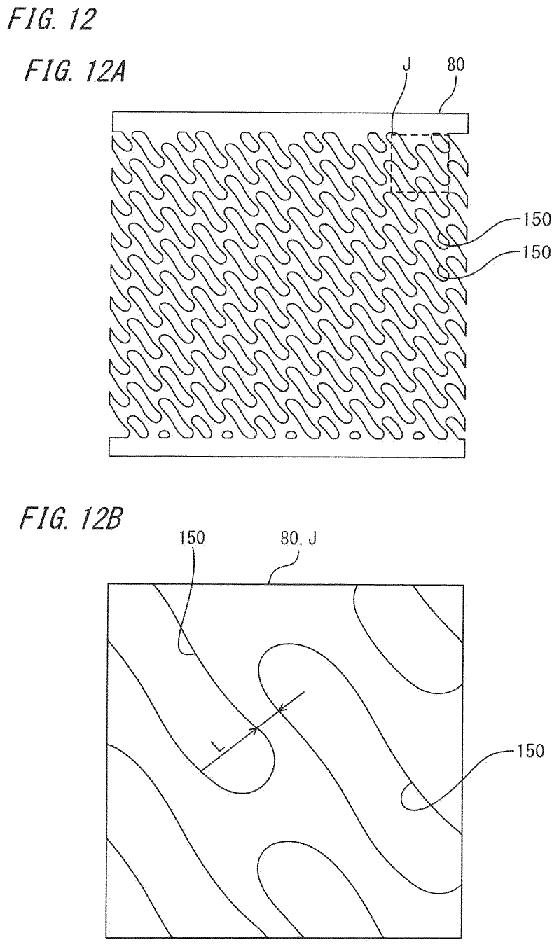

FIG. 12A is a plan view showing a configuration of a plate of a heat sink according to embodiment 3. FIG. 12B is an enlarged plan view showing a configuration of a broken-line part J of the plate shown in FIG. 12A. FIG. 13 is a side view of the plate of the heat sink according to embodiment 3.

In a heat sink 100 according to the present embodiment 3, a shortest distance L between the adjacent holes 150 formed in the plate 80 is not less than a thickness T (FIG. 13) of the plate 80. For example, in a case of forming the holes 150 of the plate 80 by stamping, if the shortest distance L between the adjacent holes 150 is not less than the thickness T of the plate 80, a part having the shortest distance L between the adjacent holes 150 can be prevented from being broken off or producing shear droop.

In the heat sink configured as in the above embodiment 3, the same effects as in the above embodiments are provided, and in addition, the plates are each formed such that a shortest distance between the holes adjacent to each other is not less than a thickness of the plate.

Thus, the plate can be prevented from being broken off or producing shear droop.

### Embodiment 4

In a heat sink according to embodiment 4, the total number of the stacked plates 80 is denoted by N (N is an integer not less than 7 in a case of an odd number or is an integer not less than 6 in a case of an even number). In a case where N is an odd number, the number of kinds of patterns of the holes 150 of the plates 80 is ((N−1)/2)+1. In a case where N is an even number, the number of kinds of patterns of the holes 150 of the plates 80 is N/2.

As shown in FIG. 7, FIG. 8, and FIG. 9, the shapes of the helical flow paths 800 are symmetric with respect to the helix center axes 13 and the stacking direction Y of the plates 80. Accordingly, if the thicknesses T of the plates 80 are appropriately selected and stacking is performed such that the shapes of the holes 150 of the plates 80 in the stacking direction Y are symmetric about the helix center axes 13, helical shapes can be formed. Therefore, in a case where N is an odd number, the number of kinds of patterns of the holes 150 of the plates 80 to be prepared is ((N−1)/2)+1. In a case where N is an even number, the number of kinds of patterns of the holes 150 of the plates 80 to be prepared is N/2.

Thus, as compared to a case where the kinds of patterns of the holes 150 of the N plates 80 are all different from each other, the number of kinds of patterns of the holes 150 of the plates 80 can be decreased, so that productivity is improved.

In the heat sink configured as in the above embodiment 4, the same effects as in the above embodiments are provided, and in addition,
where a total number of the plates is denoted by N, N being an integer not less than 7 in a case of an odd number or being an integer not less than 6 in a case of an even number,
in a case where N is an odd number, a number of kinds of the patterns is ((N−1)/2)+1, and in a case where N is an even number, a number of kinds of the patterns is N/2.

Thus, the number of kinds of the patterns of the holes of the plates can be decreased, so that productivity is improved.

### Embodiment 5

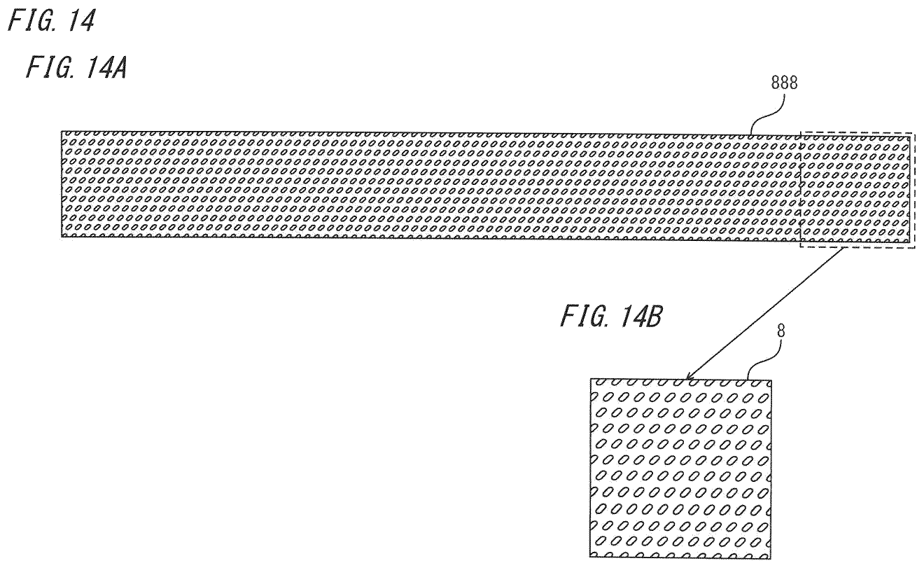

FIG. 14A is a plan view showing a configuration of a fin portion material 888 for manufacturing a fin portion 8 of a heat sink according to embodiment 5. FIG. 14B is a plan view showing a configuration of the fin portion 8 cut out from the fin portion material 888 shown in FIG. 14A. In embodiment 5, for example, plate materials which correspond to the plates 81 to 89 having patterns of the holes 151 to 159 as shown in FIG. 5 and whose areas on a plane are not smaller than two times the area of the fin portion 8, are formed (first step).

Next, the plate materials are stacked in the stacking direction Y (second step) and then are brought into close contact with each other or joined to each other, so as to be manufactured as the fin portion material 888 (FIG. 14A, third step). Next, from the fin portion material 888, a part having a necessary size (broken-line part in FIG. 14B) is cut out in accordance with desired sizes of the flow paths 800, to manufacture the fin portion 8 (FIG. 14B, fourth step).

In manufacturing of the fin portion 8 having the flow paths 800, a process of performing close-contact pressing, brazing, diffusion welding, or friction stir welding between the plates 80 in the stacking direction Y includes a largest number of steps and requires cost. Therefore, in the present embodiment 5, the fin portion material 888 larger than the size of the fin portion 8 having the flow paths 800 to be needed is manufactured in advance as described above.

Thereafter, a plurality of fin portions 8 having predetermined sizes are cut out. With this manufacturing, in a case of forming a plurality of fin portions 8 having the flow paths 800 to be needed, a process of performing close-contact pressing, brazing, diffusion welding, or friction stir welding, which would include the largest number of steps, can be performed at once, so that the number of steps can be significantly decreased.

In the heat sink configured as in the above embodiment 5, the same effects as in the above embodiments are provided, and in addition,
after a fin portion material is formed by performing the first to third steps using plate materials having areas not smaller than two times an area of the fin portion, the method includes a fourth step of cutting out a plurality of the fin portions from the fin portion material.

Thus, in a case of manufacturing a plurality of heat sinks, the number of steps can be significantly decreased.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1 base portion
100 heat sink
13 helix center axis
150 hole
151 hole
152 hole
153 hole
154 hole
155 hole
156 hole
157 hole
158 hole
159 hole
16 flow line
17 O ring
19 step portion
2 heat generation body
3 fastening plate
4 bolt
5 supply path
6 discharge path
7 water jacket
8 fin portion
80 plate
800 flow path
81 plate
82 plate
83 plate
84 plate
85 plate
86 plate
87 plate
88 plate
89 plate
810 part
811 part
812 part
813 part
814 part
888 fin portion material
9 flow path entrance
L shortest distance
T thickness
Y stacking direction
X perpendicular direction
Z flowing direction

1. A heat sink having a fin portion in which a plurality of plates are stacked in a stacking direction, wherein
a flowing direction of a cooling liquid introduced into the heat sink is a direction perpendicular to the stacking direction,
each of the plates has a plurality of holes,
in a state in which the plates are stacked in the stacking direction, flow paths formed by the holes of the plates being connected to each other in the stacking direction and the flowing direction have helical shapes toward the flowing direction, and
helix center axes at helix centers of the flow paths are formed in only one row in the stacking direction.

2. The heat sink according to claim 1, wherein
the fin portion has a plurality of kinds of the plates with different patterns of the holes.

3. The heat sink according to claim 2, wherein
where a total number of the plates is denoted by N, N being an integer not less than 7 in a case of an odd number or being an integer not less than 6 in a case of an even number,
in a case where N is an odd number, a number of kinds of the patterns is ((N−1)/2)+1, and
in a case where N is an even number, a number of kinds of the patterns is N/2.

4. The heat sink according to claim 1, wherein
the flow paths are formed in a plurality of rows in a perpendicular direction perpendicular to the stacking direction and the flowing direction.

5. The heat sink according to claim 4, wherein
the flow paths are formed such that the flow paths adjacent in the perpendicular direction are partially connected to each other.

6. The heat sink according to claim 1, wherein
a plurality of heat generation bodies are allowed to be mounted to the heat sink, and the flow paths are formed in only areas into which heat is transferred from the respective heat generation bodies.

7. The heat sink according to claim 1, wherein
the plates adjacent in the stacking direction are formed by being pressed into close contact with each other in the stacking direction.

8. The heat sink according to claim 1, wherein
a joined portion is formed at parts where the plates adjacent in the stacking direction contact with each other.

9. The heat sink according to claim 8, wherein
the joined portion is formed by brazing.

10. The heat sink according to claim 8, wherein
the joined portion is formed by diffusion welding.

11. The heat sink according to claim 8, wherein
the joined portion is formed by friction stir welding.

12. The heat sink according to claim 1, wherein
the plates are each formed such that a shortest distance between the holes adjacent to each other is not less than a thickness of the plate.

13. A method for manufacturing the heat sink according to claim 1, the method comprising:
a first step of forming the plurality of holes in each of the plates; and
a second step of stacking the plates in the stacking direction so that the holes of the plates are connected to each other in the stacking direction and the flowing direction, thus forming the flow paths having helical shapes toward the flowing direction.

14. The method for manufacturing the heat sink, according to claim 13, further comprising a third step of applying a pressure in the stacking direction so that the plates adjacent in the stacking direction are pressed into close contact with each other, after the second step.

15. The method for manufacturing the heat sink, according to claim 13, further comprising a third step of joining, by brazing, parts where the plates adjacent in the stacking direction contact with each other, after the second step.

16. The method for manufacturing the heat sink, according to claim 13, further comprising a third step of performing diffusion welding at parts where the plates adjacent in the stacking direction contact with each other, after the second step.

17. The method for manufacturing the heat sink, according to claim 13, further comprising a third step of performing friction stir welding at parts where the plates adjacent in the stacking direction contact with each other, after the second step.

18. The method for manufacturing the heat sink, according to claim 14, wherein
after a fin portion material is formed by performing the first to third steps using plate materials having areas not smaller than two times an area of the fin portion,
the method comprises a fourth step of cutting out a plurality of the fin portions from the fin portion material.

19. The heat sink according to claim 2, wherein
the flow paths are formed in a plurality of rows in a perpendicular direction perpendicular to the stacking direction and the flowing direction.

20. The heat sink according to claim 3, wherein
the flow paths are formed in a plurality of rows in a perpendicular direction perpendicular to the stacking direction and the flowing direction.
